(19) United States
(12) Patent Application Publication
(10) Pub. No.: US 2023/0368202 A1
(43) Pub. Date: Nov. 16, 2023

(54) SYSTEM AND METHOD OF SERVICE THROUGH A DISTRIBUTED LEDGER

(71) Applicant: JIO PLATFORMS LIMITED, Ahmedabad (IN)

(72) Inventors: Dilip KRISHNASWAMY, Karnataka (IN); Aayush BHATNAGAR, Maharashtra (IN); Kanchan CHAUHAN, Maharashtra (IN); Dipender BHAMRAH, Maharashtra (IN); Rajesh Kumar SUBUDHI, Maharashtra (IN)

(21) Appl. No.: 18/246,435

(22) PCT Filed: Mar. 28, 2022
(86) PCT No.: PCT/IB2022/052829

§ 371 Date: Mar. 23, 2023

(30) Foreign Application Priority Data
Mar. 31, 2021 (IN) 202121014968

(51) Int. Cl. G06Q 20/40; G06Q 20/38

(52) U.S. Cl. CPC G06Q 20/401; G06Q 20/389

(57) ABSTRACT

The present invention relates to a system and method for managing operational data pertaining to a service through a distributed ledger with minimal or no manual intervention. The system enables a user and an entity (and third party for fund processing) to perform an incremental data management, rate card management that may be acceptable to both the user and entity for efficient fund processing. The system and method of the present disclosure facilitates managing operational data pertaining to service to reduce the associated costs and time related to reconciliation as well as to reduce manual verification efforts. The system also enables additional IoT based implementation that can result in fully automated system with true estimation of the energy consumption by inter communication between multiple ledger networks and IoT.

### FIELD OF INVENTION

The embodiments of the present disclosure generally relate to distributed ledger. More particularly, the present disclosure relates to a secure, authentic and reliable manner for managing operational data pertaining to a service through a distributed ledger.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Service providers provide service or a facility to service users such that the service may include variable consumption of one or more operational aspects. This may often require both the parties to manually update their records for generation of a summary pertaining to compensation amount to be paid to the service provider after pre-defined number of services or after regular time intervals. As an example, the user may be an operator of a telecom service having a need to host a radio-frequency (RF) equipment and the service provider may be a multiple infrastructure partner whose infrastructure may be utilized by the user to host the RF equipment. An operational fund or compensation may be related to one or more attributes of service provided by the entity such as, for example, fuel and power consumed by the RF equipment and other such attributes that may be incremental or variable in nature. Based on the service, a summary or a bill may be generated for the consumed fuel and power. In an existing eco-system, the summary generation or the billing management is completely manual and generated in silos by all stakeholders with no transparency leading to multiple re-conciliations and delays before actual pay out may happens. FIG. 1 illustrates a flow diagram (100) showing a conventional process for management of operation parameters pertaining to a service and associated funds. The representation in FIG. 1 pertains to a fixed energy model (102) that is used conventionally for summary or bill generation. As shown at 104, at a fixed time duration or date of each month, service providers may discuss with service users (operators) to finalize a Rate Card (such as Diesel and Electricity rate) for their circle/state for preceding month, wherein similar exercise may be done for all the circles where the user (operator) has availed the service of service providers. At 106, based on agreed Rate card that forms one of the variable metrics for the bill calculation, along with other variable metrices, the service providers may generate a bill (Itemized bill and Digital Invoice copy) for that preceding month and send it circle wise, or site wise, over email to the users. At 108, the users or their managers manually verify the bill (based on the rate card received from service provider and variable metrices available with user) and may send it for manual approval to the financial team. At 110, once the bill may be approved by the user or circle, the same is processed for the bill payment. In case of mismatch in the billing amount sent by the service provider and calculated by user, multiple cycles of communication via mails, phone calls and the like, may happen until an agreeable bill amount is negotiated or certain variables metrices are modified. The final amount may be processed and paid through approval workflow by user's financial team. Such conventional systems involve no transparency, no consistency and requires manual efforts. Further, in services such as energy billing that may be considered to be one of the most costly service, any delay and inconsistency may lead to huge losses to either the service provider or user, which highlights the ineffectiveness of the conventional processes.

There is therefore a need in the art to provide a system and a method that can enable to manage operational data and record management pertaining to a service in an efficient, automated, transparent, secure and reliable manner.

### Objects of the Present Disclosure

Some of the objects of the present disclosure, which at least one embodiment herein satisfies are as listed herein below.

It is an object of the present disclosure to provide a system and a method for managing operational data pertaining to a service, in an efficient, transparent and reliable manner.

It is an object of the present disclosure to provide a system and a method for managing operational data pertaining to a service, with minimal or no manual intervention.

It is an object of the present disclosure to provide a system and a method for managing operational data pertaining to a service to reduce the associated costs and time related to reconciliation as well as to reduce manual verification efforts.

### SUMMARY

This section is provided to introduce certain objects and aspects of the present invention in a simplified form that are further described below in the detailed description. This summary is not intended to identify the key features or the scope of the claimed subject matter.

In an aspect, the present disclosure provides for a system for automated management of one or more operational parameters pertaining to a service of an entity to a user. The system may include a distributed ledger, and a smart contract. The distributed ledger may be operatively coupled to an entity device associated with the entity and a user device associated with the user and the smart contract may include one or more processors coupled to the distributed ledger. The one or more processors may be further coupled with a memory that may store instructions which when executed by the one or more processors cause the smart contract to: receive, a set of data packets from any or a combination of the user device, one or more nodes associated with one or more smart metering units, the set of data packets pertaining to one or more services to be availed by the user. The smart contract may extract, a first set of attributes from the set of data packets received, the set of attributes pertaining to an incremental data that may pertain to usage or consumption of the one or more operational parameters of the service by the user or user device. The smart contract may further compare, the first set of attributes with a set of parameters stored in a knowledgebase operatively coupled to the distributed ledger, the set of parameters pertaining to the one or more operational parameters of the service consumed by the user or the user device. Upon comparison, the smart contract may determine, a difference in data indicative of a discrepancy in the first set of attributes and the set of parameters. The comparison may be continued until the difference in data corresponds to zero and then generate, a fund summary pertaining to an operational fund in exchange of the one or more services provided by the entity. Furthermore, the smart contract may auto-update the distributed ledger with a date and a time stamp based on the generated fund summary.

The present disclosure further provides for a method for automated management of one or more operational parameters pertaining to a service of an entity to a user. The method may include the steps of receiving, by a smart contract, a set of data packets from any or a combination of the user device, one or more nodes associated with one or more smart metering units, the set of data packets pertaining to one or more services of the entity to be availed by the user. The smart contract may include one or more processors coupled to a distributed ledger, wherein the one or more processors are further coupled with a memory. The method may further include the step of extracting, by the smart contract, a first set of attributes from the set of data packets received, said set of attributes pertaining to an incremental data that may pertain to usage or consumption of the one or more operational parameters of the service by the user or user device and then the method may perform the step of comparing, by the smart contract, the first set of attributes with a set of parameters stored in a knowledgebase operatively coupled to the distributed ledger, the set of parameters pertaining to the one or more operational parameters of the service consumed by the user or the user device. Upon comparison, the method may include the step of determining, by the smart contract, a difference in data, said difference in data indicative of a discrepancy in the first set of attributes and the set of parameters, wherein the comparison is continued until the difference in data corresponds to zero. Further, the method may include the step of generating, by the smart contract, a fund summary pertaining to an operational fund in exchange of the one or more services provided by the entity. Furthermore, the method may include the step of auto-updating, by the smart contract, the distributed ledger with a date and a time stamp based on the generated fund summary.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates a flow diagram (100) showing a conventional process of management of operation parameters pertaining to a service and associated funds.

FIG. 2A illustrates an exemplary network architecture (200) in which or with which the system of the present disclosure can be implemented, in accordance with an embodiment of the present disclosure.

FIG. 2B illustrates an exemplary representation (250) of various nodes in a network associated with the distributed ledger, in accordance with an embodiment of the present disclosure.

FIG. 2C illustrates an exemplary representation (270) of first server (212) or second server (214) of FIG. 1, in accordance with an embodiment of the present disclosure.

FIGS. 3A-3C illustrate a flow diagrams depicting various interactions and processes involved in managing operational parameters pertaining to a service, in accordance with an embodiment of the present disclosure.

FIG. 4 illustrates an exemplary representation (400) of a state transition graph for rate card pertaining to a service provided by an entity, in accordance with an embodiment of the present disclosure.

FIG. 5 illustrates an exemplary representation (500) of a state transition graph for operational fund to be transferred to an entity for a service, in accordance with an embodiment of the present disclosure.

FIG. 6A illustrates an exemplary overview (600) of an additional aspect of IoT based smart metering for implementation in the architecture of FIG. 1, in accordance with an embodiment of the present disclosure.

FIG. 6B illustrates an exemplary overview (650) of a system with a smart metering implementation including modules pertaining to multiple energy sources and dynamic pricing, in accordance with an embodiment of the present disclosure.

FIG. 7 refers to the exemplary computer system (700) in which or with which embodiments of the present invention can be utilized, in accordance with embodiments of the present disclosure.

The foregoing shall be more apparent from the following more detailed description of the invention.

### BRIEF DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention provides a system and a method for automated management of operational parameters pertaining to a service. One of the main intent of the present disclosure lies in implementing a distributed ledger based automated system, that can enable a service providing entity and a service user to manage one or more aspects of the service in a reliable and transparent manner such that one or more records of the operational data/parameters pertaining to the service are automatically updated in the distributed ledger for ease of reference. In an aspect, the present disclosure enables implementation of a smart contract to enable the service providing entity and the service user to access the records with ease for minimizing all efforts otherwise needed in reconciliation processes or manual verification of records, while avoiding the associated costs and time.

In an embodiment, the distributed ledger may be a blockchain. The distributed ledger may be integrated with an implementation of a smart contract, which can be generated and updated for ease of reference of the service providing entity and the service user. The term “smart contract” (interchangeably referred hereinafter as digital contracts) may refer to a digital agreement which can be accessed via computing or electronic devices and automatically generated and/or updated based on information received from, for example, the user, entity, one or more nodes associated with fund processing units or the distributed ledger and other such sources. In an embodiment, the system of the present disclosure may enable implementation of a distributed ledger based on micro-services with an executable set of instructions on user device or entity device supporting execution of a smart contract, wherein the smart contract may be configured to generate a summary (such as a bill) pertaining to an operational fund in exchange of the service provided by the entity such that the generated summary may be error-free and acceptable by both the user and the entity.

In an embodiment, the entity may be any individual, group of individuals or an organization that may offer one or more facilities or services related to, without limitation, to consumer products, telecom services, facility renting services, administrative services, and any other provider of facilities/services. Various other facilities and/or services may be included. The user may be an individual, group of individuals or an organization that may be recipient of any or a combination of above mentioned facilities and/or services, such that the user may be liable to transfer an operational fund in exchange of the service provided by the entity. In an exemplary embodiment, the user may be an operator of a telecom service having a need to host a radio-frequency (RF) equipment and the entity may be a multiple infrastructure partner whose infrastructure may be utilized by the user (operator) to host the RF equipment. In this embodiment, the operational fund may be related to one or more attributes of service provided by the entity such as, for example, fuel and power used by the RF equipment and other such attributes. The present disclosure may enable implementation of a micro-service based distributed ledger platform, such as for example, a blockchain for adding transparency, consistency and automation to generating and maintaining the summary that is error-free. In an exemplary embodiment, the summary may relate to a billing or invoice for an operational fund such as a payment pertaining to the RF equipment hoisting facility. In an embodiment, the user and the entity may be able to provide, using a set of executable instructions on respective user/entity devices, an input information pertaining to the service. The input information may include any or a combination of invariable data and a variable data. In an exemplary embodiment and considering the previous example, the variable data may include factors that may change or vary with time and/or in an incremental manner such as, including, but not limited to, tenancy count, number of RF equipment hosted by infrastructure partner, units of power and fuel consumed and various other parameters. In an exemplary embodiment and considering the previous example, the invariable data may include factors that may not vary much with time or in an incremental manner such as, including, but not limited to, site details addresses, site ID, equipment codes or other non-varying information pertaining to the user, respective equipment/facility and various other parameters. The input information may also include rate card that indicates charges for per unit of an operational parameter of a service. In an embodiment, the rate card may be variable or invariable and may be provided by the entity. Based on the provided information by the user and entity, the system may execute a smart contract and endorse the data while updating a distributed ledger such that difference in data (differential data) provided by the user and entity that may be indicative of the discrepancy in the data, may be minimal. In an exemplary embodiment, the system may provide the differential data until the differential data corresponds to zero indicating that the user and/or the entity may be in agreement with each other, based on which a final summary or bill may be generated and updated in the ledger accessible via smart contract execution.

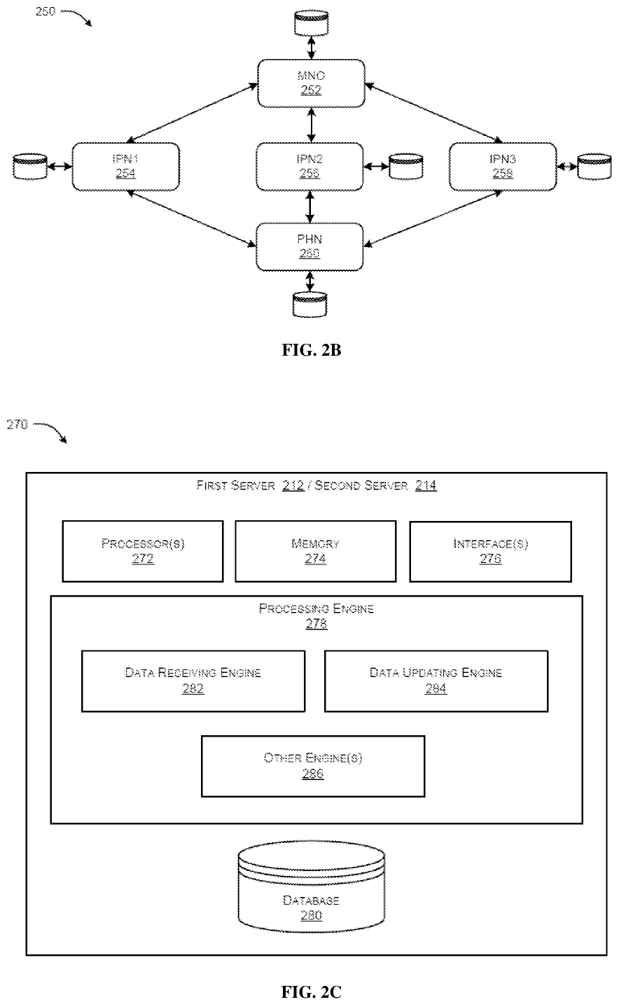

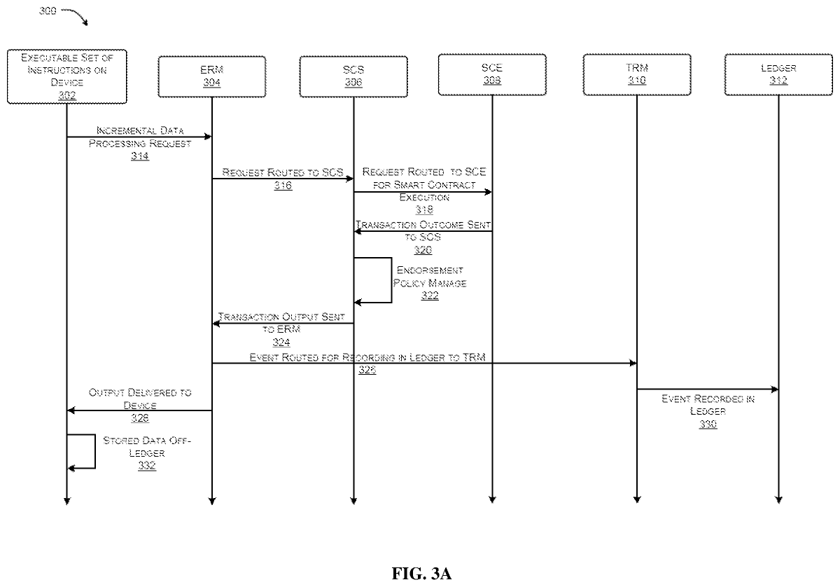

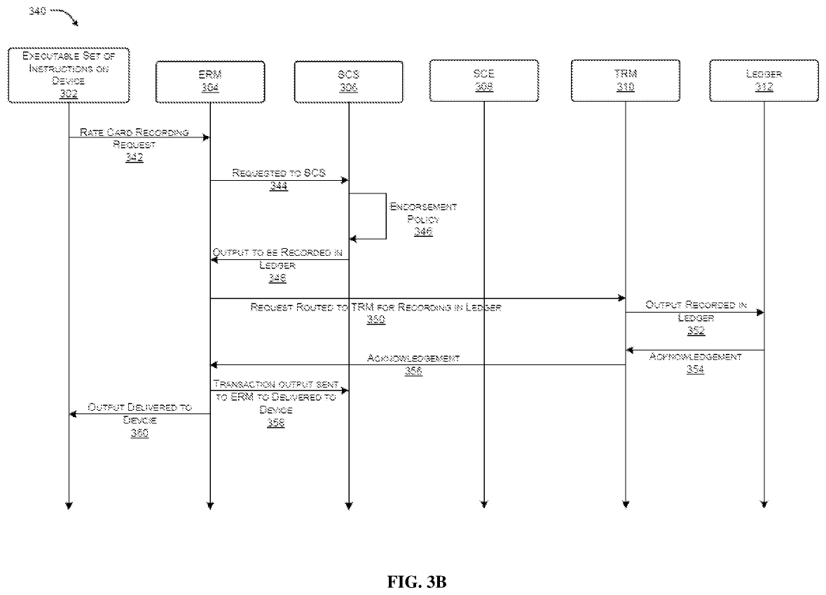

FIG. 2A illustrates an exemplary network architecture (200) in which or with which a system of the present disclosure can be implemented, in accordance with an embodiment of the present disclosure. As illustrated, the system may include a first server (214) communicating with an entity device (220) associated with an entity (210). The system may also include a second server (212) communicating with a user device (204) associated with a user (202). The first server (214) and the second server (212) may be part of a network associated with a distributed ledger (230). In an exemplary embodiment, the distributed ledger (230) may be a blockchain. The entity device (220) and the user device (204) may be communicably coupled to the first server (214) and the second server (212) respectively, through a communication network (not shown). In an embodiment, the system of the present disclosure may enable implementation of the distributed ledger based on micro-services through generation and/or update of a smart contract. In an embodiment, the smart contract may be accessible to the user (202) and the entity (210) on their respective devices through an executable set of instructions. The system may also include a third-party server (not shown) pertaining to a third party such as service providers related to fund transfer and other such financial/other services. In an embodiment, the distributed ledger (230) may include a network that may involve nodes pertaining to the user, entity and other parties (such as fund transfer related service providers).

In an embodiment, the user (202) and the entity (210) may be able to provide an input information including a variable and/or a non-variable information such that the information may be updated at the respective servers and corresponding records may be updated accessed by smart contract and updated on the distributed ledger. The variable information may include an incremental data that may pertain to usage or consumption of one or more parameters of the service by the user or user equipment, which may be provided by the user (202) and/or the entity (210). In an embodiment, the input information from the entity may include data pertaining to a rate at which the incremental data or the consumption may be estimated, such as, for example, a rate card for power consumption and other such services. Based on the provided information, the system/servers may process a difference in data (differential data) indicative of the discrepancy in the data provided by the user (202) and/or the entity (210). In an exemplary embodiment, the system/servers may provide the differential data until the differential data corresponds to zero indicating that the user (202) and/or the entity (210) may be in agreement with each other. In an embodiment, based on the final processed information in which the differential data may be zero, the smart contract may be configured to generate a fund summary pertaining to an operational fund in exchange of the service provided by the entity such that the generated summary may be error-free and acceptable by both the user and the entity. In an embodiment, corresponding records pertaining to the updated information and the generated summary may be updated on the distributed ledger, wherein the record may include a date and time stamp for reliable and better transparency. The system present disclosure may thereby save enormous time, expenses and efforts otherwise involved in manual processing, reconciliation, and manual verification in case of conventional processing.

FIG. 2B illustrates an exemplary representation of various nodes in a network (250) associated with the distributed ledger (230) of FIG. 2A, in accordance with an embodiment of the present disclosure. The network (250) in the representation in FIG. 2B mainly illustrates an exemplary embodiment involving the previously mentioned example of user being an operator with a requirement to host RF equipment whereas the entity may provide a facility, such as, for example, a tower for hosting the RF equipment. The other figures being discussed hereinafter may also relate to the mentioned example. However, it may be appreciated that the present disclosure may not be limited to this example, but also can be implemented in several use cases or applications involving any entity providing a facility and/or a service to a user in exchange to an operational fund such that the service includes incremental data or any variable information, based on which a total fund summary pertaining may be issued. In all other use cases or applications as well, the present disclosure may enhance the transparency, authenticity of overall process while reducing the need to invest manual efforts, time and expenses in reconciliation or other such procedures. The distributed ledger network (250) may include a distributed set of network nodes interacting with one another, each having local distributed ledger based micro-services providing support for the interaction. As illustrated in FIG. 2B, the network (250) may include a plurality of partner nodes including, but not limited to, a Mobile Network Operator (MNO) Node (252), a node each for each partner also termed as (IPN) (IPN1—254, IPN2—256, IPN3—258), a Payment Handler node (PHN) (260). Various other nodes may be including depending on the requirements as per particular embodiments. Each node may be associated with respective databases (as shown in the FIG. 2B). The network (250) may aim to minimize a delta or differential data in the variable input information such as, for example, the incremental data or variable information received from both the user (operator) and the entity (partner) to zero or to an agreed threshold value. By controlling the limit on incremental data or the variable information, the variation in fund as displayed on the generated summary may also be within acceptable values.

The MNO node (252) may be the interface for administrators or representatives pertaining to the user (hereinafter interchangeably also referred to as operator) and may allow the user to feed a master and incremental data. In an embodiment, the master data may be an invariable data including factors that may not vary much with time or that may not change in an incremental manner such as, including, but not limited to, site details addresses, site ID, equipment codes or other non-varying information pertaining to the user, respective equipment/facility and various other parameters. In an embodiment, the variable data may include factors that may vary with time and/or in an incremental manner such as, including, but not limited to, tenancy count, number of RF equipment hosted by infrastructure partner, units of power and fuel consumed and various other parameters. In an exemplary embodiment and considering the previous example, the invariable data may include factors that may not vary much with time or in an incremental manner such as, including, but not limited to, site details addresses, site ID, equipment codes or other non-varying information pertaining to the user, respective equipment/facility and various other parameters. In an embodiment, each IPN node (254, 256, 258) may be partner interfacing node that may allow the entity (interchangeably also referred to as partner) to feed information such as, for example, a rate card pertaining to charges for one or more aspects of the service, and/or a variable information, such as, for example, an incremental data. Various other types of information may be provided by the partner. In an embodiment, the PHN node (260) may be provide an interface towards the fund processing system, also referred to as a payment processing system (SAP). The PHN node (260) may act as the interface for the fund related operations or service providers pertaining to the operational fund.

In an exemplary, embodiment, the incremental data may be received from the user and/or the entity for different sites through an implementation, such as, for example, an Application Programming Interface (API) call, a file upload and other file sharing mechanism. In an embodiment, the API approach may be used to make the process fully automated with minimal manual intervention. Upon recording any change in an operational parameter pertaining to input information (such as variable data), the respective system of user and/or entity may be updated, which can trigger the API call to an executable set of instruction (device application) pertaining to the distributed ledger (on respective user and entity devices) to submit the change. Upon receiving the change, a smart contract running in the executable set of instruction will compare the incremental data from the user and/or the entity and may share the mismatches (differential data) with all parties in the distributed ledger network (user, entity, fund processing parties and others). The parties may then take corrective action at their end and correct the system data such that that the data may be compared by smart contract until there is no mismatch (differential data). In an embodiment, one or more records or states of transition may be recorded in the ledger and actual data may be stored off ledger at the executable set of instruction. In another embodiment, another smart contract may be used to generate summary of fund upon receipt of information such as rate card, incremental data and other such data after endorsement by the user, entity and other involved parties, wherein a summary generation logic may be executed for generation of summary such as, for example, a bill, invoice or other summary. The generated summary may be committed or updated in the ledger after due endorsements from user, entity and other involved parties. The generated summary may then be pursued further processing at fund processing system (SAP). The distributed ledger may capture or update various states of processing.

In an exemplary embodiment, each node may support a lazy update to ledger of other nodes thus eventually leading to a consistent distributed ledger system. In an embodiment, any node may be a producer node at a predefined time and any node may be consumer node at that predefined time. For example, the execution of smart contract may compare incremental data received by MNO node (252) and IPN node (254, 256, 258) such that the smart contract may be executed at MNO node (252) and may be endorsed by both the MNO node (252) and IPN nodes (254, 256, 258). The system may utilize a comparison logic to produce a set of data that may be mismatched and may need correction such that once corrected, the incremental data set may be endorsed. In another embodiment, a rate card fed by IPN nodes (254, 256, 258) may be endorsed by the MNO node (252) and IPN nodes (254, 256, 258) such that a summary may be generated by a smart contract executed at MNO node (252) and endorsed by MNO node (252), IPN node (254, 256, 258) and PHN node (260). Various other embodiments may be possible within the scope of the present disclosure. In an embodiment, one or more state transitions or changes pertaining to aspects such as the rate card, the generated summary and other such aspects may be recorded and/or updated in the distributed ledger.

The nodes of the network (250) may operate one or more components or units pertaining to management of operation, including, but not limited to, an event routing manager (ERM), smart contract execution (SCE) service, smart contract streaming (SCS) service, Transaction Manager (TRM) and other aspects. Each node may include one or more micro-services to perform one or more tasks within the node. In an embodiment, the micro-services may pertain to the ERM that may receive one or more event updates from the nodes defined such that it invoke the SCE for operation or execution of required logic, such as comparing incremental data and summary generation. The outcome of the execution may be sent for endorsements and subsequently SCS may be invoked to validate the submitted transactions with respect to the endorsement policies. The endorsed transaction may be routed to the TRM for committing/updating in the ledger.

In an embodiment, the smart contract may be accessed by the user, entity and/or a third party by using their respective user device, entity and third party devices (collectively termed as device/devices) through an executable set of instructions associated with the distributed ledger and the smart contract execution. The devices may be a portable device with the operable/executable set of instructions residing on an operating system, including but not limited to, Android™, iOS™, and the like. In an embodiment, devices may include, but not limited to, any electrical, electronic, electro-mechanical or an equipment or a combination of one or more of the above devices such as mobile phone, smartphone, laptop, a general-purpose computer, desktop, personal digital assistant, tablet computer, mainframe computer, or any other computing device. The devices may include one or more in-built or externally coupled accessories including, but not limited to, a visual aid device such as camera, audio aid, a microphone, a keyboard, input devices for receiving input from a user such as touch pad, touch enabled screen, electronic pen and the like. It may be appreciated that the devices may not be restricted to the mentioned devices and various other devices may be used.

In an embodiment, the servers (112, 114) may include one or more processors coupled with a memory, wherein the memory may store instructions which when executed by the one or more processors may cause the system to perform an automated management of operational data/parameters pertaining to a service through distributed ledger. FIG. 2C with reference to FIG. 2A, illustrates an exemplary representation of the first server (114) and the second server (112), in accordance with an embodiment of the present disclosure. In an aspect, the servers (112, 114) may comprise one or more processor(s) (272). The one or more processor(s) (272) may be implemented as one or more microprocessors, microcomputers, microcontrollers, digital signal processors, central processing units, logic circuitries, and/or any devices that process data based on operational instructions. Among other capabilities, the one or more processor(s) (272) may be configured to fetch and execute computer-readable instructions stored in a memory (274). The memory (274) may be configured to store one or more computer-readable instructions or routines in a non-transitory computer readable storage medium, which may be fetched and executed to create or share data packets over a network service. The memory (274) may comprise any non-transitory storage device including, for example, volatile memory such as RAM, or non-volatile memory such as EPROM, flash memory, and the like.

In an embodiment, the servers (112, 114) may include an interface(s) 276. The interface(s) 276 may comprise a variety of interfaces, for example, interfaces for data input and output devices, referred to as I/O devices, storage devices, and the like. The interface(s) 276 may facilitate communication. The interface(s) 276 may also provide a communication pathway for one or more components of the servers (112, 114). Examples of such components include, but are not limited to, processing engine(s) 278 and a database 280.

The processing engine(s) (278) may be implemented as a combination of hardware and programming (for example, programmable instructions) to implement one or more functionalities of the processing engine(s) (278). In examples described herein, such combinations of hardware and programming may be implemented in several different ways. For example, the programming for the processing engine(s) (278) may be processor executable instructions stored on a non-transitory machine-readable storage medium and the hardware for the processing engine(s) (278) may comprise a processing resource (for example, one or more processors), to execute such instructions. In the present examples, the machine-readable storage medium may store instructions that, when executed by the processing resource, implement the processing engine(s) (278). In such examples, the servers (112, 114) may comprise the machine-readable storage medium storing the instructions and the processing resource to execute the instructions, or the machine-readable storage medium may be separate but accessible to the servers (112, 114) and the processing resource. In other examples, the processing engine(s) (278) may be implemented by electronic circuitry.

The processing engine (278) may include one or more engines selected from any of a data receiving engine (282), a data updating engine (284), and other engines (286). In an embodiment, the data receiving engine (282) may enable to receive a data such as input information such as, invariable data such as the master data and variable data such as the incremental data and other such information from the user, entity and other third parties. In an embodiment, the data updating engine (284) may receive updates pertaining to change/alteration of information such as, for example, updated incremental data received from user and/or entity based on the differential data received from the system. Various other updated information can be received. In an embodiment, the other engines (286) may include a notification engine, authentication engine and other such engines required to accomplish one or more events pertaining to the automated management of operational parameters pertaining to a service through distributed ledger. The database (280) may comprise data that may be either stored or generated as a result of functionalities implemented by any of the components of the processing engine(s) 278 of server (112, 114). The database (210) may also enable to store input information, generated summary and other such details pertaining to one or more steps.

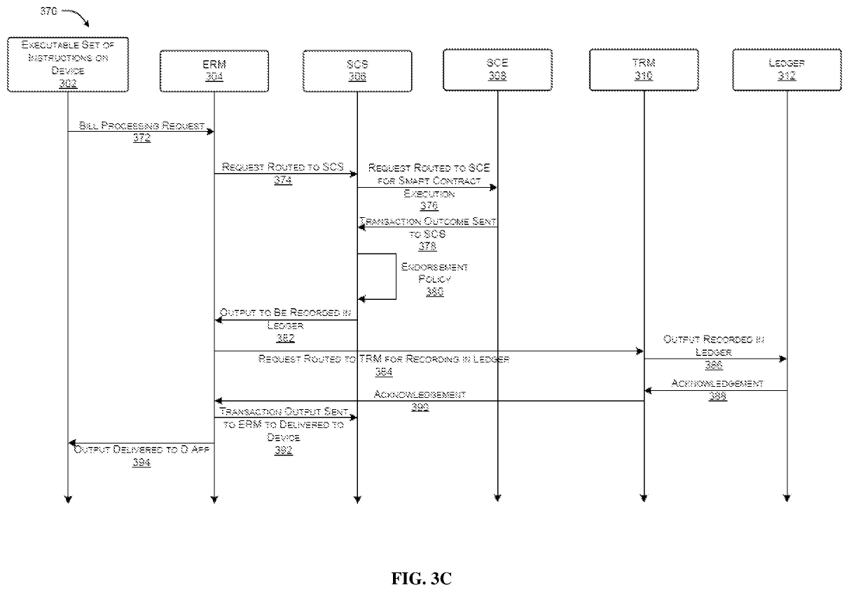

FIGS. 3A-3C illustrate a flow diagrams depicting various interactions and processes involved in managing operational data pertaining to a service, in accordance with an embodiment of the present disclosure. FIGS. 3A-3C illustrate a method and various steps of a method for managing operational data pertaining to a service. The method described herein involves an interaction between different components such as executable set of instructions on device (user and entity devices) (302), ERM (304), SCS (306), SCE (308), TRM (310) and a ledger (312). FIG. 3A illustrates a flow diagram (300) showing an overview (300) of how incremental data received is incorporated or recorded in distributed ledger. As illustrated in FIG. 3A, at 314, an incremental data processing request is received at the ERM (304) from the set of instructions on the user and/or entity devices. In an embodiment, each node of distributed ledger network may include micro-services that may perform one or more tasks within the nodes. In an example, the micro-services may pertain to the ERM (304) that may receive one or more event updates from the nodes defined such that it invoke the SCE (308) for operation or execution of required logic, such as comparing incremental data and summary generation. At 316, the incremental data processing request may be routed from the ERM (304) to the SCS (306), and at 318, the request may be further routed to SCE (308) for smart contract execution. In an embodiment, the outcome of the execution may be sent for endorsements and subsequently SCS (306) may be invoked to validate the submitted transactions with respect to the endorsement policies. At 320, the outcome of the execution may be sent from SCE (308) to SCS (306). At 320, the SCS (306) may enable endorsement pertaining to the outcome. At 324, an output of the endorsement may be sent to the ERM (304) and the event may be routed to TRM (310) for recording in ledger (312). At 330, the event may be recorded in the ledger (312), At 328, an output may be delivered to the device (302) and at 332, the actual output may be stored off ledger (312).

FIG. 3B illustrates a flow diagram (340) showing an overview (300) of an approval workflow for a rate card submission. In an embodiment, the approval for rate card submission may not include a smart contract execution. At 342, a rate card recording request may be forwarded from the device (302) to the ERM (304), and at 344, the request may be forwarded to the SCS (306). At 346, the SCS (306) may enable endorsement pertaining to the request. At 348, an output of the same may be forwarded to the ERM (304) for recording in the ledger (312). At 350, a request may be routed to TRM (310) for recording the output in the ledger, and at 352, the output may be sent to the ledger (312) for recording the output. At 354, an acknowledgement may be sent to TRM (310) and at 356, the TRM may forward acknowledgement to ERM (304). At 358, transaction output may be forwarded to SCS (306) for delivering to device (302) and at 360, the output may be delivered to the device (302).

FIG. 3C illustrates a flow diagram (370) showing an overview (300) indicating generation of a summary pertaining to an operational fund related to the service provided by the entity. In an exemplary embodiment, and in reference to FIG. 3B and FIG. 2B, the summary may be generated by MNO when rate card may be approved and mismatch in the incremental data (differential data) may be zero or an agreeable or acceptable predefined threshold value. Once the summary may be generated, event may be recorded in the ledger along with the summary details. As illustrated in FIG. 3C, at 372, a summary processing request may be sent from the device (302) to the ERM (304). In an embodiment, the summary may refer to a bill, an invoice and other such details pertaining to a compensation amount that may be charged by entity for service provided to user. At 374, the summary processing request may be forwarded to SCS (306). At 376, the summary processing request may be forwarded to SCE (308) for execution/update of smart contract. At 378, an outcome of the transaction may be sent to SCS (306) and at 380, the outcome may be endorsed. At 382, the output of the endorsement may be forwarded to ERM (304) for subsequent recording in the ledger (312). At 384, a request may be routed to TRM (310) for recording the output in ledger (312) and at 386 the output may be recorded in the ledger. At 388, an acknowledgement may be sent to TRM (310) and at 390, the TRM may forward acknowledgement to ERM (304). At 392, transaction output may be forwarded to SCS (306) for delivering to device (302) and at 394, the output may be delivered to the device (302).

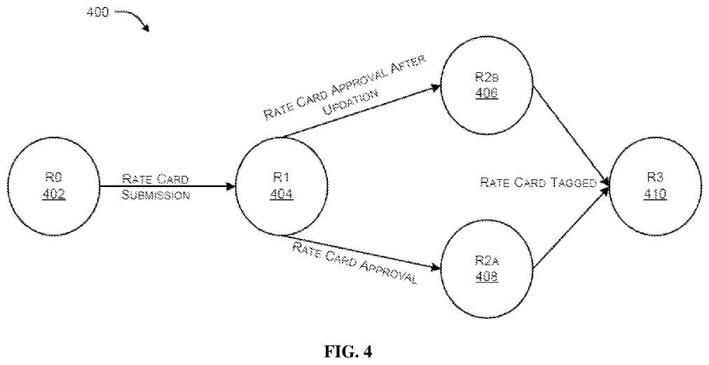

FIG. 4 illustrates an exemplary representation (400) of a state transition graph for rate card pertaining to a service provided by an entity, in accordance with an embodiment of the present disclosure. The flow diagram (400) indicates various states in the workflow related to rate card. As shown, a state R0 (402) may involve rate card submission to achieve a state R1 (404). In an exemplary embodiment, and in reference to FIG. 3B and FIG. 2B, for rate card submission, the IPN may be submitting party, the MNO and IPN may be endorsing party. At the state R1 (404), the rate card may be approved to achieve a state R2A (408) and/or the rate card approval after updating to achieve a state R2B (406). In an exemplary embodiment, and in reference to FIG. 3B and FIG. 2B, for rate card approval, the MNO may be submitting party, the MNO and PHN may be the endorsing party. At any of the states R2A (408) and/or R2B (406), the rate card may be tagged to achieve a state R3 (410). In an exemplary embodiment, and in reference to FIG. 3B and FIG. 2B, for rate card tagging, the MNO may be submitting party, the MNO and PHN may be the endorsing party. Various other states or steps are also possible.

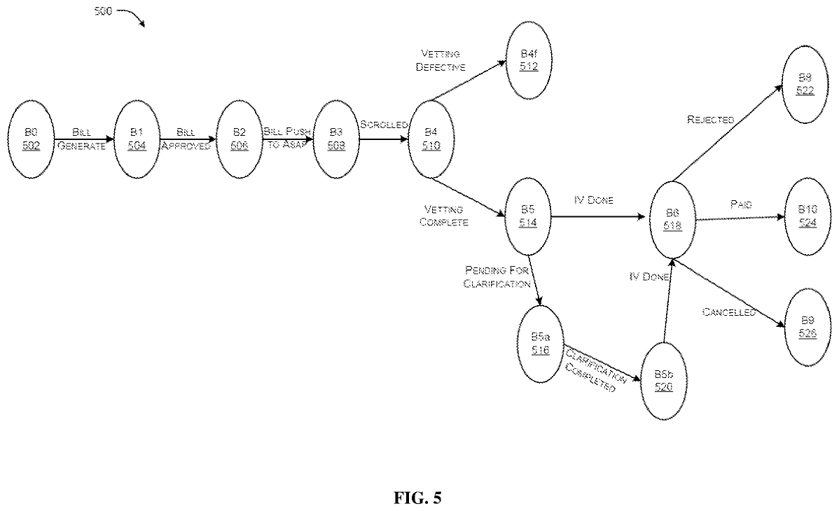

FIG. 5 illustrates an exemplary representation (500) of a state transition graph for operational fund to be transferred to an entity for a service, in accordance with an embodiment of the present disclosure. In an exemplary embodiment and as shown in FIG. 5, the summary may be a bill pertaining to the service provided by the entity to the user. At state B0 (502), a bill may be generated to achieve a state B1 (504). At state B1 (504), a bill may be approved by user and/or entity to achieve a state B2 (506). At state B2 (506), a bill may be forwarded to fund processing system (SAP) to achieve a state B3 (508). At state B3 (508), a bill may be scrolled to achieve a state B4 (510). In an embodiment, the states from B4 onwards depict interaction of SAP with the distributed ledger. At state B4 (510), a bill may be vetted to achieve a state B4f (512) pertaining to a defective vetting OR a state B5 (514) pertaining to the vetting being complete. At state B5 (514), a bill may be pending for clarification to achieve a state B5a (516) such that the clarification may be completed to achieve a state B5b (520) and further internal vetting may be done to achieve a state B6 (518). Alternatively, at the state B5 (514), a bill may be directly subjected to internal vetting to achieve a state B6 (518). At state B6 (518), a bill may be rejected to achieve a state B8 (522) OR may be paid to achieve a state B10 (524) OR may be cancelled to achieve a state B9 (526). Various other states or steps are also possible.

In another aspect, the present disclosure comprises implementation of dynamic smart contracts with a smart metering for recording information based on plurality of sensors pertaining to internet of Things (IoT) for improving the accuracy of distributed ledger-based updates in smart contract execution. In an embodiment, the IoT implementation may include plurality of sensors that facilitate the automated sensing for the smart metering operation. The sensors may include, but not limited to, thermal sensors, quality measurement sensors quantity measuring sensors, visual sensors, audio sensors, power consumption measurement sensors, mechanical sensors, energy attributes measurement sensors, electrical attributes measurement sensors, fuel consumption measurement sensors and other such sensors. Various other sensors may also be used. In an aspect, the smart metering may facilitate to rectify the differential data with respect to the input information (variable and/or invariable) used in generation of fund summary between the user and the entity through smart contracts and endorsements. In an embodiment, the smart metering may automatically lead to generation of the fund summary that may be acceptable to both the parties (user and entity), thus resolving the limitations of delay, lack of transparency and possibility of inconsistent data provided by the parties as in the case of conventional processes brings. In an embodiment, the variable information may be estimated dynamically by smart metering for measurement of one or more parameters. For example, in case of previously mentioned example, the parameters may include power consumption, measurement of fuel consumption distributed between multiple RF equipment pertaining to multiple tenants hosted on a tower and other such parameters. In another aspect, the system may enable utilization of multiple sources of energy that may include traditional sources, renewable sources and other sources of energy. The present disclosure may enable implementation of various energy sources into the system into a common module that may facilitate selection of one or more types of energy sources from the multiple energy sources as per the requirements of the user/entity. In an exemplary embodiment, smart metering can also be done to capture fractional utilization of the multiple sources of energy along with consideration of dynamic pricing at the time of the usage, based on utilization at a given time interval such that an overall energy cost may be computed for a duration such as a month, six months and other such duration. In an exemplary embodiment, the computation of the overall energy cost may be done in a smart contract and the result may be recorded in a distributed ledger along with various inputs (pertaining to consumption, dynamic pricing and other such aspects) for each time interval. In another embodiment, the fractional energy usage for each user (such as operator or tenant) may also be captured along with the residual fraction for shared usage of the infrastructure provided by the entity (infrastructure provider). Various other parameters may be possible to be continuously monitored through smart metering. In an embodiment, the smart metering (IoT implementation) in combination with the smart contract implementation associated with the distributed ledger-based update may enhance accuracy, transparency and fairness that provides a fully automated system. Various other embodiments or scenarios are possible.

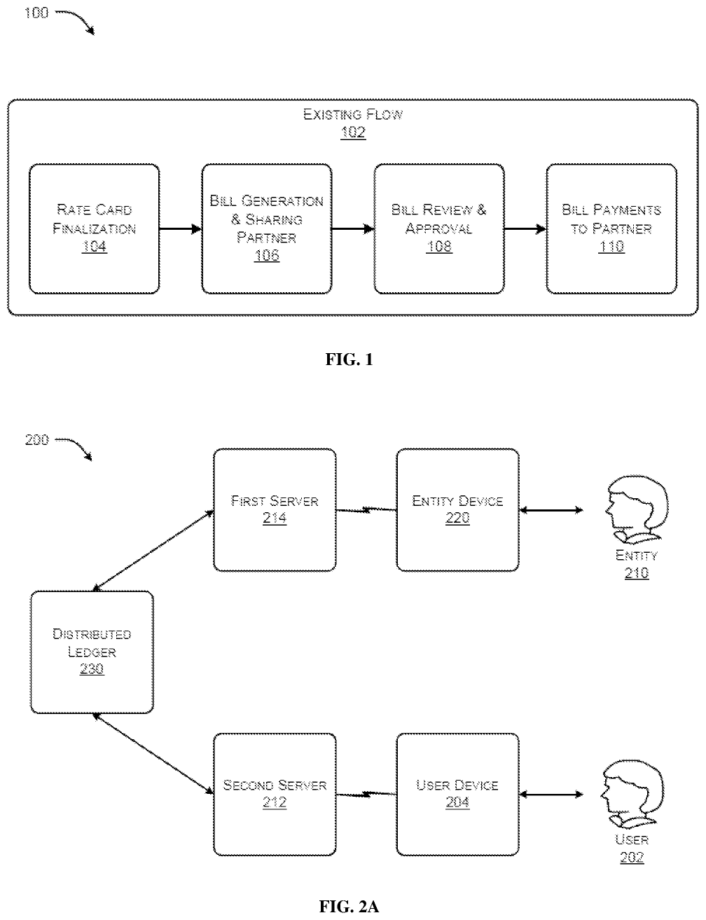

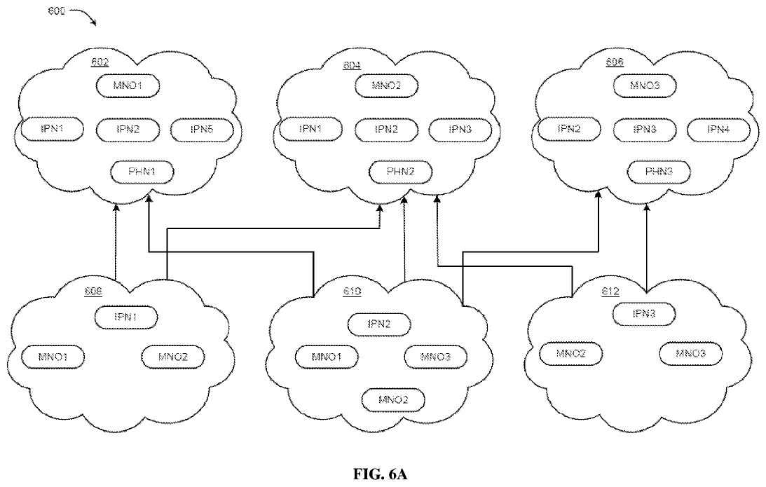

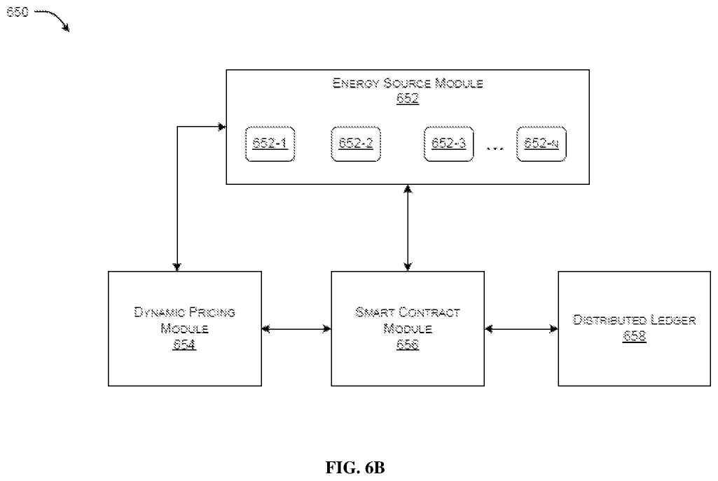

In an embodiment pertaining to additional IoT implementation, the present disclosure discloses system and method may be further enabled to address problems related to lack of information pertaining to actual consumption and lack of true estimation in data provided by the user and/or the entity. For example, power and fuel consumption metrics have a direct relationship with number of tenants hosted by the infrastructure partner (entity) and the number of RF units installed by operator (user) may have been assumed as fixed numbers for different permutations of the number of tenants and RF units, which may not give the actual consumption and also may not be a true estimation. This may lead to overestimation or even under estimation in some cases of the generated summary or bill that the operator (user) has to bear. The present disclosure provides a mechanism that has enhanced transparency and may enable to a true measure of the consumed energy. In an embodiment, the present disclosure may include a distributed ledger framework that may implement dynamic smart contracts and dynamic configurations by way of inter-communication between different small ledger networks. The system may also include additional networks, wherein each network may include an entity (such as infrastructure partner) and user (operators) that the partner hosts such that these ledger networks may communicate with each other to share a true estimate of the parameters, for example, power and fuel consumed. FIG. 6A illustrates an exemplary overview of an additional aspect of IoT based smart metering for implementation in the architecture of FIG. 1, wherein several ledger networks (600) may be involved, in accordance with an embodiment of the present disclosure. For example, one category of the ledger network may be (602, 604, 606) that includes nodes pertaining to a user (telecom operator or MNO), entity (multiple Infrastructure partner or IPN) and its fund processing nodes (payment handler node or PHN) (as explained in FIG. 2B). In the same example, another category of ledger network (608, 610, 612) may include entity (Infrastructure partner) along with all the users (operators or tenants) as hosted by the entity. In an exemplary embodiment, an actual usage of an operational parameter of a service may be estimated by IoT smart meter by implementing a plurality of sensors to validate the usage of the parameters of the service such as fuel/energy source at any given time, hosted at the entity site and shared transparently between all ledger networks including the operator and its infrastructure partners. These dynamic configurations or smart metering may be combined or implemented with smart contracts for accurate and transparent summary generation.

FIG. 6B illustrates an exemplary overview (650) of a system with a smart metering implementation including modules pertaining to multiple energy source and dynamic pricing, in accordance with an embodiment of the present disclosure. As indicated in FIG. 6B, the system may include an energy source module (652) that may facilitate utilization of multiple sources of energy (shown as 652-1, 652-2, 652-3 and 652-n). In an embodiment, the multiple sources of energy may include, without limitation, traditional sources such as energy from the utility or electricity board, or from diesel generation and other such sources, renewable sources such as green energy sources including, but not limited to, solar energy, wind energy and other such sources. In an embodiment, the green energy sources may be implemented in addition to the energy inputs from the utility or electricity board, or from diesel generation and other such sources. The present disclosure may enable implementation of various energy sources into the system through the common energy source module (652) that may facilitate selection of one or more types of energy sources from the multiple energy sources as per the requirements of the user/entity. In an exemplary embodiment, smart metering can also be done to capture fractional utilization of the multiple sources of energy such that dynamic pricing at the time of the usage, based on utilization at a given time interval that may be taken into account to compute an overall energy cost for a duration such as a month, six months and other such duration. The dynamic pricing may be regularly updated in a dynamic pricing module (654). In an embodiment, the dynamic pricing module (654) may receive constant updates from energy markets for each of the individual energy sources such that the updated dynamic pricing can be can incorporated and the average pricing for a time interval of usage of a given energy source can be computed by the system. The energy markets may be local such as micro-grid or may be aggregated across a larger geographical area and estimated such that the dynamic pricing may be agreed across various stakeholders that would be utilized in a smart contract for overall energy cost computation. Various other techniques to obtain dynamic pricing information may be possible. The computation of the overall energy cost may be done in a smart contract module (656) and the result along with record of energy utilization for each time interval and/or dynamic pricing may be recorded in a distributed ledger (or a blockchain ledger) (658), wherein inputs for the computation may be obtained by the smart metering technique enabled by the energy source module (652) and the dynamic pricing module (654). In another embodiment, the fractional energy usage for each user (such as MNO or tenant) may also be captured with the residual fraction for the shared usage of the infrastructure. In an exemplary embodiment, for an overall billing in a collective larger period such as, one day or one month or other period or duration, the values are aggregated across the time-intervals that comprise the larger period in accordance with equations such as provided herein below for better understanding. Various other calculations are possible. In an embodiment, the stakeholders or the concerned parties that need to be aware or updated (such as the MNOs that share infrastructure node) may be given access to this information. Thus, as illustrated in FIG. 6B, the system may enable an implementation wherein different energy sources, along with different pricing information for each energy source, and fractional MNO tenant usage as well as shared infrastructure usage may be considered for each time interval for effective automated computing of overall costs that avoids manual efforts as well as significantly enhances the accuracy of energy utilization and/or computed costs for tenants, which may be impossible to achieve manually or by other conventional techniques.

In an exemplary embodiment, microgrids may be used for providing energy into the system, such that smart metering may be implemented to measure the amount of energy derived from green source. For example, it may be assumed that there are k possible energy sources, the smart meters for each of the possible k energy fuel/energy sources may measure the amount of energy utilized from each energy source. For a given interval of time ΔTᵢ, the k different energy sources may be used and the amount of energy consumed (in units such as kWh) during these fractional intervals of time may be given by E₁(ΔTᵢ), E₂(ΔTᵢ), . . . , Eₖ(ΔTᵢ), respectively as monitored by the smart meters associated with these energy sources. In an embodiment, the average cost per unit energy of utilization (units of dollars per kWh for example) of each of these k energy sources during this time interval may be given by c₁(ΔTᵢ), c₂(ΔTᵢ), . . . cₖ(ΔTᵢ). Then the total energy cost (in dollars or alternative currency) to the tower operator for utilizing these energy sources during this time interval may be given by

$$E {C}_{t o t} ( Δ {T}_{i} ) = {\sum }_{j = 1}^{k} {c}_{j} ( Δ {T}_{i} ) {E}_{j} ( Δ {T}_{i} )$$

In an embodiment, if there may be M(ΔTᵢ) tenants (users or RF equipment of users) being supported at a tower during the time interval ΔTᵢ. During this time interval, each of the M(ΔTᵢ) tenants utilize a fraction of time given by η₁(ΔTᵢ), η₂(ΔTᵢ), . . . , η_{M}(ΔTᵢ) respectively for the radio heads/units/resources operated by the tenant. Let us assume that α(ΔTᵢ)=Σₘ₌₁^{M(ΔT}^{ᵢ}⁾ ηₘ(ΔTᵢ). A residual fraction of time η₀(ΔTᵢ)=(1−Σₗ₌₁^{M} ηₘ(ΔTᵢ))=(1−α(ΔTᵢ)) may be utilized by the overall tower infrastructure such that this residual fraction may correspond to common cooling costs, or common energy transduction inefficiency costs, or other common energy losses, that are incurred in the system. The tenants may agree to share this fractional common energy utilization costs proportionately based on their respective utilizations. One option may be that each tenant m takes responsibility for the fraction

$$\frac{{η}_{m} ( Δ {T}_{i} )}{α ( Δ {T}_{i} )} {η}_{0} ( Δ {T}_{i} )$$

of the common energy utilized in the tower. In that case, for the utilized energy, each tenant m is billed for an amount given by

$$E {C}_{m} ( Δ {T}_{i} ) = E C ( Δ {T}_{i} ) ( {η}_{m} ( Δ {T}_{i} ) + \frac{{η}_{m} ( Δ {T}_{i} )}{α ( Δ {T}_{i} )} {η}_{0} ( Δ {T}_{i} ) ) = E C ( Δ {T}_{i} ) {η}_{m} ( Δ {T}_{i} ) ( 1 + \frac{η o ( Δ {T}_{i} )}{α ( Δ {T}_{i} )} ) = E C ( Δ {T}_{i} ) \frac{{η}_{m} ( Δ {T}_{i} )}{α ( Δ {T}_{i} )}$$

for the time interval ΔTᵢ.

### Thus,

$$E {C}_{m} ( Δ {T}_{i} ) = E C ( Δ {T}_{i} ) \frac{{η}_{m} ( Δ {T}_{i} )}{α ( Δ {T}_{i} )}$$

Alternatively, the tenants may choose to share the residual energy fraction cost equally, in which case each of the M(ΔTᵢ) tenants takes responsibility for a fraction

$$\frac{η o ( Δ {T}_{i} )}{k} .$$

In that case, each tenant m is billed for an amount given by

$$E {C}_{m} ( Δ {T}_{i} ) = E C ( Δ {T}_{i} ) ( {η}_{m} ( Δ {T}_{i} ) + \frac{η o ( Δ {T}_{i} )}{M ( Δ {T}_{i} )} )$$

In an embodiment, capital expenditure costs may have to amortized over a period of time based on a rate of Cₛₜₐₜ dollars per unit time, or that there are dynamic capital or maintenance costs C_{dyn}(ΔTᵢ) that are incurred during a specific time interval ΔTᵢ, so that the overall capital cost is represented as

Cap(ΔTᵢ)=(CₛₜₐₜΔTᵢ+C_{dyn}(ΔTᵢ))

If this cost may be shared equally amongst the M(ΔTᵢ) tenants, then such a capital cost for tenant m may be given by

$${Cap}_{m} ( Δ {T}_{i} ) = ( \frac{{C}_{s t a t} Δ {T}_{i} + {C}_{dyn} ( Δ {T}_{i} )}{M ( Δ {T}_{i} )} )$$

If this cost may be shared amongst the M(ΔTᵢ) tenants proportional to energy utilization, then such a capital cost for tenant m is given by

$${Cap}_{m} ( Δ {T}_{i} ) = ( {C}_{s t a t} Δ {T}_{i} + {c}_{dyn} ( Δ {T}_{i} ) ) \frac{{η}_{m} ( Δ {T}_{i} )}{α ( Δ {T}_{i} )} .$$

Then the total cost this is billed for a specific tenant m for the time interval ΔTᵢ may be given by the equation

TCₘ(ΔTᵢ)=ECₘ(ΔTᵢ)+Capₘ(ΔTᵢ)

In an embodiment, the energy utilization per tenant over a billing period that includes multiple interval sub-durations of time ΔTᵢ maybe then added to determine the overall cost for each tenant, given by Σᵢ TCₘ(ΔTᵢ). To enable the summarized approach for generation of summary or a bill, required parameters Cₛₜₐₜ, C_{dyn}(ΔTᵢ), M(ΔTᵢ), Σⱼ(ΔTᵢ)∀j, ηₘ(ΔTᵢ)∀m, may be recorded on the distributed ledger or blockchain with dynamic parameters such as Σⱼ(ΔTᵢ)∀j, ηₘ(ΔTᵢ)∀m, monitored using smart meters. In an exemplary embodiment, sharing mechanism (such as equally shared or proportional to tenant usage) may be encoded in smart contracts on the platform, so that billing per tenant can be determined during an overall billing period that could include multiple interval sub-durations of length ΔTᵢ. In an embodiment, with emerging 5G and future networks programmable infrastructure, decision making in the control plane (such as a decision made at a DU (Distributed Unit) for a Radio Unit (RU) that the DU controls) for dynamic resource allocation (such as dynamic allocation of a remote radio head) in such infrastructure can be recorded in distributed ledger or blockchain to determine dynamic costs of utilization of such tower infrastructure or facilities. It may be appreciated that the present disclosure may not be limited to the above-mentioned example and/or calculations but several different embodiments or aspects may be possible within the scope of the present disclosure.

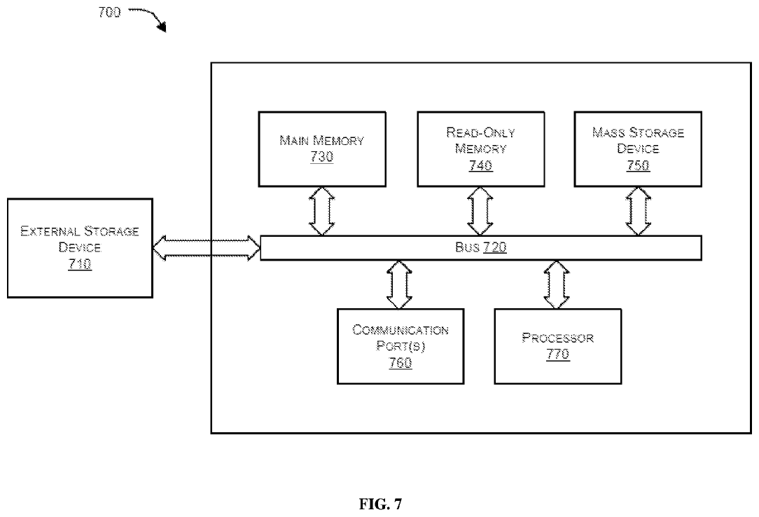

FIG. 7 refers to the exemplary computer system (700) in which or with which embodiments of the present invention can be utilized, in accordance with embodiments of the present disclosure. As shown in FIG. 7, a computer system 1000 can include an external storage device 710, a bus 720, a main memory 730, a read only memory 740, a mass storage device 750, communication port 760, and a processor 770. A person skilled in the art will appreciate that the computer system may include more than one processor and communication ports. Examples of processor 770 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 770 may include various modules associated with embodiments of the present invention. Communication port 760 can be any of an RS-232 port for use with a modem based dialup connection, a 10/100 Ethernet port, a Gigabit or 10 Gigabit port using copper or fibre, a serial port, a parallel port, or other existing or future ports. Communication port 760 may be chosen depending on a network, such a Local Area Network (LAN), Wide Area Network (WAN), or any network to which computer system connects. Memory 730 can be Random Access Memory (RAM), or any other dynamic storage device commonly known in the art. Read-only memory 740 can be any static storage device(s) e.g., but not limited to, a Programmable Read Only Memory (PROM) chips for storing static information e.g., start-up or BIOS instructions for processor 770. Mass storage 750 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 720 communicatively couples processor(s) 770 with the other memory, storage and communication blocks. Bus 720 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 770 to software system.

Optionally, operator and administrative interfaces, e.g. a display, keyboard, and a cursor control device, may also be coupled to bus 720 to support direct operator interaction with a computer system. Other operator and administrative interfaces can be provided through network connections connected through communication port 760. The external storage device 710 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Thus, the present disclosure provides a unique and inventive solution for managing operational data pertaining to a service through a distributed ledger with minimal or no manual intervention. The system and method of the present disclosure facilitates managing operational data pertaining to a service to reduce the associated costs and time related to reconciliation as well as to reduce manual verification efforts. The system and method also enables implementation of operation data pertaining to, for example, energy billing process in a permissioned private micro-service based ledger platform resulting in a system that has the ability to increase fairness and trust, reduce processing time, and eliminate processing errors with transparency, automation, and distributed trust. The system also enables additional IoT based implementation that can result in fully automated system with true estimation of the energy consumption by inter communication between multiple ledger networks and IoT. The present disclosure also ensures that dynamic parameters needed for summary generation can be recorded in the ledger platform, with dynamic monitoring of information using smart meters, to determine the overall summary generation or billing for a given tenant during a billing period. Several other advantages may be realized from the embodiments of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### ADVANTAGES OF THE PRESENT DISCLOSURE

The present disclosure provides for a system and a method for managing operational data pertaining to a service, in an efficient, transparent and reliable manner.

The present disclosure provides for a system and a method for managing operational data pertaining to a service, with minimal or no manual intervention.

The present disclosure provides for a system and a method for managing operational data pertaining to a service to reduce the associated costs and time related to reconciliation as well as to reduce manual verification efforts.

We claim:

1. A system for automated management of one or more operational parameters pertaining to a service of an entity to a user, the system comprising:
a distributed ledger operatively coupled to an entity device associated with the entity and a user device associated with the user;
a smart contract comprising one or more processors coupled to the distributed ledger, wherein the one or more processors are further coupled with a memory, wherein said memory stores instructions which when executed by the one or more processors causes the smart contract to:
receive, a set of data packets from any or a combination of the user device, one or more nodes associated with one or more smart metering units, said set of data packets pertaining to one or more services to be availed by the user;
extract, a first set of attributes from the set of data packets received, said set of attributes pertaining to an incremental data that may pertain to usage or consumption of the one or more operational parameters of the service by the user or user device;
compare, the first set of attributes with a set of parameters stored in a knowledgebase operatively coupled to the distributed ledger, the set of parameters pertaining to the one or more operational parameters of the service consumed by the user or the user device;
upon comparison, determine, a difference in data, said difference in data indicative of a discrepancy in the first set of attributes and the set of parameters, wherein the comparison is continued until the difference in data corresponds to zero;
generate, a fund summary pertaining to an operational fund in exchange of the one or more services provided by the entity; and
auto-update the distributed ledger with a date and a time stamp based on the generated fund summary.

2. The system as claimed in claim 1, wherein implementation of the distributed ledger is based on a plurality of micro-services through generation and/or update of the smart contract.

3. The system as claimed in claim 1, wherein the distributed ledger is a blockchain associated with one or more radio frequency (RF) equipments.

4. The system as claimed in claim 3, wherein the distributed ledger comprises a distributed set of network nodes interacting with one another, each having a local distributed ledger based micro-services providing support for an interaction.

5. The system as claimed in claim 1, wherein the smart contract is further operatively coupled to a rate card management module, said rate card management module configured to manage the difference in data between the first set of attributes and the set of parameters.

6. The system as claimed in claim 1, wherein the smart contract is further configured with an incremental data management module that determines and updates incremental changes in the first set of attributes extracted.

7. The system as claimed in claim 1, wherein the smart contract is accessed via the user device or the entity device or via a third computing device associated with a third party user.

8. The system as claimed in claim 1, wherein the smart contract is operatively coupled to the smart metering units of the one or more nodes associated with the one or more services pertaining to one or more energy sources such as power grid, diesel generation, and green energy sources.

9. The system as claimed in claim 7, wherein the smart meter is operatively coupled to the user device and the entity device, wherein the smart metering unit monitors energy utilization across the energy sources for a predefined time interval, wherein the smart metering unit further monitors a fractional energy utilization per user for the predefined time interval and wherein the smart metering unit provides the monitored information as the first set of data packets to the smart contract to facilitate determination of the fund summary during the predefined time interval or across a plurality of time intervals.

10. The system as claimed in claim 1, wherein the set of data packets is updated in the smart contract every time a new user tries to establish communication with the entity.

11. A method for automated management of one or more operational parameters pertaining to a service of an entity to a user, the method comprising:
receiving, by a smart contract, a set of data packets from any or a combination of the user device, one or more nodes associated with one or more smart metering units, said set of data packets pertaining to one or more services of the entity to be availed by the user, wherein the smart contract comprises one or more processors coupled to a distributed ledger, wherein the one or more processors are further coupled with a memory;
extracting, by the smart contract, a first set of attributes from the set of data packets received, said set of attributes pertaining to an incremental data that may pertain to usage or consumption of the one or more operational parameters of the service by the user or user device;
comparing, by the smart contract, the first set of attributes with a set of parameters stored in a knowledgebase operatively coupled to the distributed ledger, the set of parameters pertaining to the one or more operational parameters of the service consumed by the user or the user device;
upon comparison, determining, by the smart contract, a difference in data, said difference in data indicative of a discrepancy in the first set of attributes and the set of parameters, wherein the comparison is continued until the difference in data corresponds to zero;
generating, by the smart contract, a fund summary pertaining to an operational fund in exchange of the one or more services provided by the entity; and
auto-updating, by the smart contract, the distributed ledger with a date and a time stamp based on the generated fund summary.

12. The method as claimed in claim 11, wherein the method further comprises:
implementing the distributed ledger based on a plurality of micro-services through generation and/or update of the smart contract.

13. The method as claimed in claim 11, wherein the method further comprises:
using the distributed ledger as a blockchain associated with one or more radio frequency (RF) equipments.

14. The method as claimed in claim 13, wherein the distributed ledger comprises a distributed set of network nodes interacting with one another, each having a local distributed ledger based micro-services providing support for an interaction.

15. The method as claimed in claim 11, wherein the smart contract is further operatively coupled to a rate card management module, said rate card management module configured to manage the difference in data between the first set of attributes and the set of parameters.

16. The method as claimed in claim 11, wherein the smart contract is further configured with an incremental data management module that determines and updates incremental changes in the first set of attributes extracted.

17. The method as claimed in claim 11, wherein the smart contract is accessed via the user device or the entity device or via a third computing device associated with a third party user.

18. The method as claimed in claim 11, wherein the smart contract is operatively coupled to the smart metering units of the one or more nodes associated with the one or more services pertaining to one or more energy sources such as power grid, diesel generation, and green energy sources.

19. The method as claimed in claim 18, wherein the smart meter is operatively coupled to the user device and the entity device, wherein the smart metering unit monitors energy utilization across the energy sources for a predefined time interval, wherein the smart metering unit further monitors a fractional energy utilization per user for the predefined time interval and wherein the smart metering unit provides the monitored information as the first set of data packets to the smart contract to facilitate determination of the fund summary during the predefined time interval or across a plurality of time intervals.

20. The method as claimed in claim 11, wherein the set of data packets is updated in the smart contract every time a new user tries to establish communication with the entity.
